(19) United States
(12) Patent Application Publication
(10) Pub. No.: US 2008/0102965 A1
(43) Pub. Date: May 1, 2008

(54) Motor Transmission/Control Assembly

(76) Inventor: Mu-Chuan HSU, Rende Township (TW)

Correspondence Address: Dr. BANGER SHIA;Int''l Patent Office of Bang Shia, 102 Lindencrest Ct, Sugar Land, TX, 77479-5201, US

(21) Appl. No.: 11/552,922

(22) Filed: Oct. 25, 2006

(51) Int. Cl. F16D 27/00

(52) U.S. Cl. 464/29

(57) ABSTRACT

A motor transmission/control assembly includes a housing, a motor, a transmission member having a first side engaged an output shaft of the motor and a second side with a first elongated protrusion, a coupling member including a first side with a second elongated protrusion and a second side with a coupling section for coupling with an external transmission element, and a shift-guiding member mounted between the transmission member and the coupling member. The shift-guiding member includes a first side with a first elongated groove slightly longer than the first protrusion of the transmission member. The shift-guiding member further includes a second side with a second elongated groove slightly longer than the second elongated protrusion of the coupling member. The first and second elongated protrusions of the transmission member are respectively engaged in the first and second elongated grooves.

### BACKGROUND OF THE INVENTION

1. Field of the Invention

The present invention relates to a motor transmission/control assembly and, more particularly, to a motor transmission/control assembly with improved stability in transmission.

2. Description of the Related Art

A typical motor includes an output end for driving a shaft or the like with or without a gear reduction device. FIG. 5 of the drawings illustrates a motor assembly with a gear reduction device. The motor assembly includes a motor 1′ and a gear reduction device 2′ having an output shaft 21′ for driving a shaft 3′. In a case that the shaft 3′ is relatively long (e.g., the shaft for a window blind or the like), the torque imparted to the shaft 3′ may cause a shift in the shaft 3′ such that the longitudinal axis of the shaft 3′ is not coincident to the longitudinal axis of the output shaft 21′. Hence, the load of the motor 1′ is increased and the noise during operation becomes larger while increasing the risk of damage to the motor 1′. A circuit board and a sensor are often provided around the motor 1′ or the shaft 3′ to control the revolution and angular position of the motor 1′, leading to significant increase in the overall volume and thus limiting the application.

### SUMMARY OF THE INVENTION

A motor transmission/control assembly in accordance with the present invention comprises a housing including a compartment, a motor mounted in the housing and including an output shaft, a transmission member mounted in the housing and including a first side engaged with the output shaft and a second side with a first elongated protrusion, a coupling member mounted in the housing and including a first side with a second elongated protrusion and a second side with a coupling section adapted for coupling with an external transmission element, and a shift-guiding member mounted in the housing and between the transmission member and the coupling member. The shift-guiding member includes a first side with a first elongated groove slightly longer than the first protrusion of the transmission member. The shift-guiding member further includes a second side with a second elongated groove slightly longer than the second elongated protrusion of the coupling member. The first and second elongated protrusions of the transmission member are respectively engaged in the first and second elongated grooves.

Preferably, the first side of the transmission member further includes a reduction section. A magnetic ring is securely mounted to the reduction section and includes a plurality of magnetic poles. A sensor is mounted in an opening in the opening and aligned with the magnetic ring for detecting the poles of the magnetic ring.

The motor transmission/control assembly in accordance with the present invention provides stable transmission without significantly increasing the overall volume. Flexible application is thus allowed.

Other objectives, advantages, and features of the invention will become more apparent from the following detailed description when taken in conjunction with the accompanying drawings.

### BRIEF DESCRIPTION OF THE DRAWINGS

FIG. 1 is an exploded perspective view of a motor transmission/control assembly in accordance with the present invention.

FIG. 2 is a sectional view of the motor transmission/control assembly in accordance with the present invention.

FIG. 3 is a sectional view similar to FIG. 2, illustrating operation of the motor transmission/control assembly.

FIG. 4 is a sectional view taken along plane 4-4 in FIG. 2.

FIG. 5 is a schematic side view of a conventional motor transmission assembly.

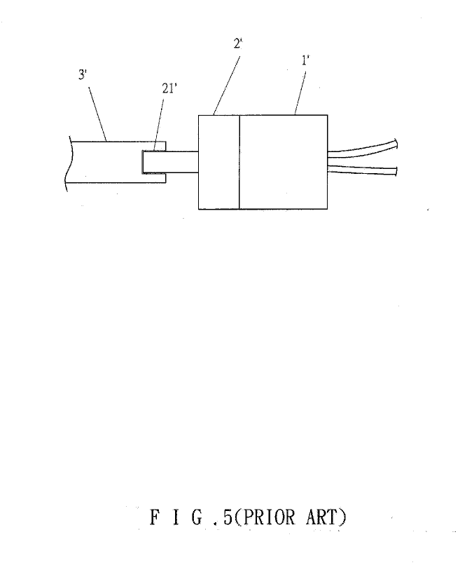

### DETAILED DESCRIPTION OF THE PREFERRED EMBODIMENT

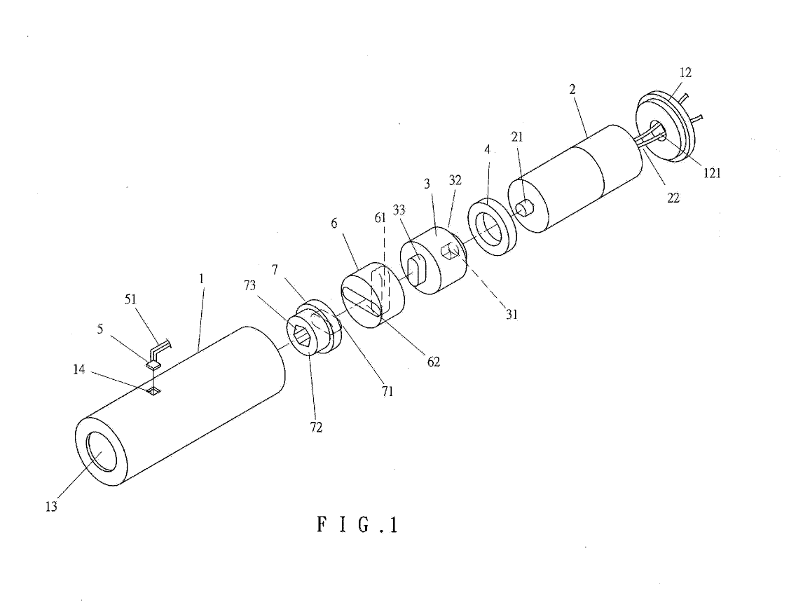

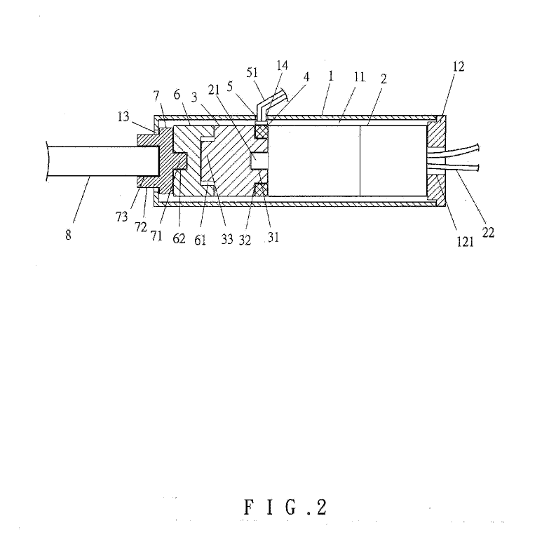

Referring to FIGS. 1 and 2, a motor transmission/control assembly in accordance with the present invention comprises a housing 1, a motor 2, a transmission member 3, a magnetic ring 4, a sensor 5, a shift-guiding member 6, and a coupling member 7. The housing 1 is made of insulating material to avoid leakage of electricity. The housing 1 includes a compartment 11, a first end with a through-hole 13, and a second end to which a cap 12 is mounted. The cap 12 has a through-hole 121 through which wires 22 of the motor 2 extends. The housing 1 further includes an opening 14 in a circumferential wall of the housing 1. The sensor 5 is mounted in the opening 14.

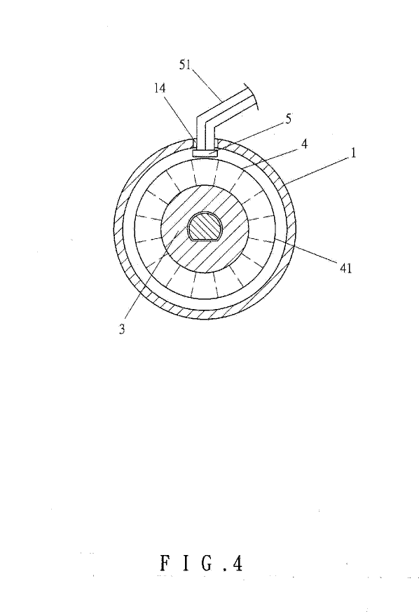

The motor 2 is mounted in the housing 1 and includes a reduction gear with an output shaft 21. The transmission member 3 is mounted in the housing 1 and includes an engaging hole 31 in a side thereof for engaging with the output shaft 21. The magnetic ring 4 is mounted by gluing or other means to a reduced section 32 formed on the side of the transmission member 3. The magnetic ring 4 includes a plurality of magnetic poles 41 (see FIG. 4). An elongated protrusion 33 is provided on the other side of the transmission member 3.

The sensor 5 is mounted in the opening 14 of the housing 1 and aligned with the magnetic ring 4. A wire 51 extends from the sensor 5 to an external circuit board (not labeled). The sensor 5 is capable of detecting the magnetic poles 41 of the magnetic ring 4.

The coupling member 7 is mounted in the housing 1 and includes an elongated protrusion 71 on a side thereof. A stub 72 is formed on the other side of the coupling member 7 and extends through the through-hole 13 of the housing 1. The stub 72 includes a coupling section 73 with a coupling hole (not labeled) for coupling with a shaft 8 or other transmission element.

The shift-guiding member 6 is mounted in the housing 1 and between the transmission member 3 and the coupling member 7. A first elongated groove 61 is defined in a first side of the shift-guiding member 6 and slightly longer than the protrusion 33 of the transmission member 33. A second elongated groove 62 is defined in a second side of the shift-guiding member 6 and slightly longer than the protrusion 71 of the coupling member 7. The first elongated groove 61 is at a right angle with the second elongated groove 62.

Referring to FIG. 2, after assembly, the output shaft 21 of the motor 2 turns to drive the transmission member 3, the shift-guiding member 6, the coupling member 7, and the shaft 8 to turn.

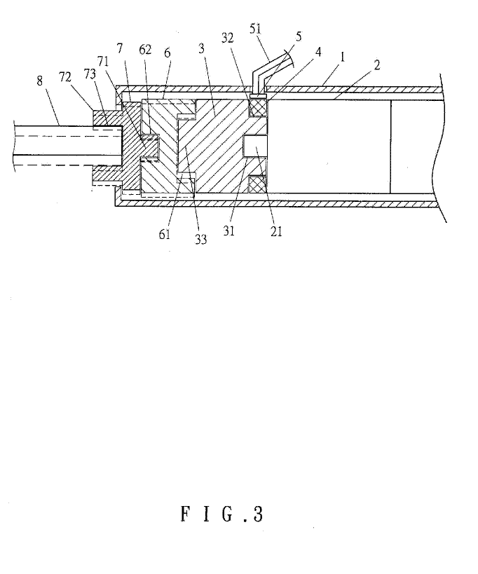

Referring to FIG. 3, in a case that a shift in the longitudinal axis of the shaft 8 occurs, the shift-guiding member 6 shifts in response to the shift of the shaft 8 to avoid damage to the output shaft 21 and to reduce the operational noise. This is due to the first and second elongated grooves 62 longer than the protrusions 33 and 71 of the transmission member 33 and the coupling member 7.

Referring to FIG. 4, the magnetic ring 4 and the transmission member 3 turn jointly. The sensor 5 detects the revolution and angular position of the magnetic ring 4, thereby allowing control of operation of the motor 2. The overall volume of the motor transmission/control assembly is not increased, allowing flexible application.

Although a specific embodiment has been illustrated and described, numerous modifications and variations are still possible. The scope of the invention is limited by the accompanying claims.

What is claimed is:

1. A motor transmission/control assembly comprising:
a housing including a compartment;
a motor mounted in the housing and including an output shaft;
a transmission member mounted in the housing and including a first side engaged with the output shaft and a second side with a first elongated protrusion;
a coupling member mounted in the housing and including a first side with a second elongated protrusion and a second side with a coupling section adapted for coupling with an external transmission element; and
a shift-guiding member mounted in the housing and between the transmission member and the coupling member, the shift-guiding member including a first side with a first elongated groove slightly longer than the first protrusion of the transmission member, the shift-guiding member further including a second side with a second elongated groove slightly longer than the second elongated protrusion of the coupling member, the first and second elongated protrusions of the transmission member being respectively engaged in the first and second elongated grooves.

2. The motor transmission/control assembly as claimed in claim 1 wherein the first side of the transmission member further includes a reduction section, further including a magnetic ring securely mounted to the reduction section, the magnetic ring including a plurality of magnetic poles, the housing further including an opening, a sensor being mounted in the opening and aligned with the magnetic ring for detecting the poles of the magnetic ring.
